(19) United States
(12) Patent Application Publication
(10) Pub. No.: US 2009/0195118 A1
(43) Pub. Date: Aug. 6, 2009

(54) SPINDLE MOTOR

(76) Inventor: Kwang Seok AN, Gwangju (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/358,565

(22) Filed: Jan. 23, 2009

(30) Foreign Application Priority Data
Jan. 23, 2008 (KR) 20-2008-0001028

(51) Int. Cl. H02K 1/18; H02K 15/14

(52) U.S. Cl. 310/216.135

(57) ABSTRACT

A spindle motor is provided. The spindle motor includes a bearing housing, a bearing, a rotation shaft, a stator, and a rotor. A guide is disposed on an outer surface of the bearing housing. The bearing is fixed in the bearing housing. The rotation shaft is rotatably supported by the bearing. The stator is fixed to the bearing housing. The stator includes a core in contact with the guide and a coil wound around the core. The rotor is fixed to the rotation shaft to rotate by interacting with the stator.

### CROSS-REFERENCE TO RELATED APPLICATION

The present application claims the benefit under 35 U.S.C. 119 of Korean Patent Application No. 20-2008-0001028, filed Jan. 23, 2008, which is hereby incorporated by reference in its entirety.

### BACKGROUND

The present disclosure relates to a spindle motor.

A spindle motor is used to rotate a disk such as a compact disk (CD) or a blu-ray disk (BD) for reading data from the disk or writing data on the disk.

In the spindle motor, a rotation shaft rotates by interaction between a rotor coupled to the rotation shaft and a stator disposed around the rotation shaft to rotate the disk.

### BRIEF SUMMARY

Embodiments provide a spindle motor.

Embodiments also provide a spindle motor in which a stator can be accurately installed in position.

In one embodiment, a spindle motor includes: a bearing housing on which a guide is disposed on an outer surface thereof; a bearing fixed in the bearing housing; a rotation shaft rotatably supported by the bearing; a stator fixed to the bearing housing, the stator comprising a core in contact with the guide and a coil wound around the core; and a rotor fixed to the rotation shaft to rotate by interacting with the stator.

The details of one or more embodiments are set forth in the accompanying drawings and the description below. Other features will be apparent from the description and drawings, and from the claims.

### BRIEF DESCRIPTION OF THE DRAWINGS

FIG. 1 is a cross-sectional view of a spindle motor according to an embodiment.

FIG. 2 is a partial enlarged view illustrating a portion “A” of FIG. 1.

### DETAILED DESCRIPTION

Hereinafter, a spindle motor according to embodiments will be described in detail with reference to the accompanying drawings.

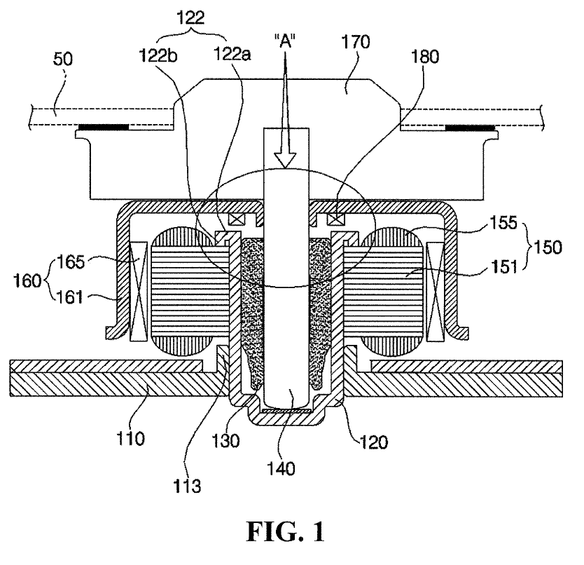

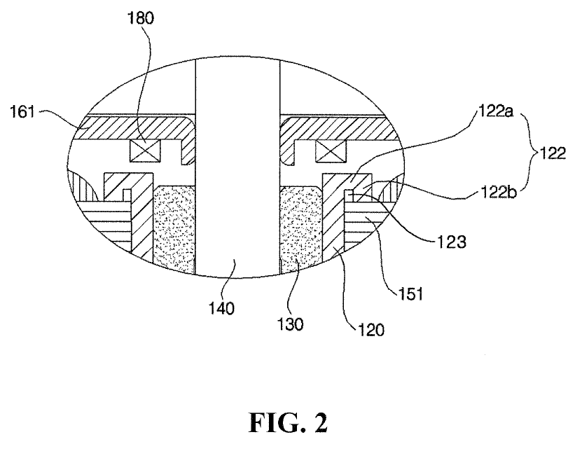

FIG. 1 is a cross-sectional view of a spindle motor according to an embodiment, and FIG. 2 is a partial enlarged view illustrating a portion “A” of FIG. 1.

Referring to FIGS. 1 and 2, a base 110 from which a coupling tube 113 protrudes is provided in a spindle motor.

The coupling tube 113 protrudes upwardly from the base 110. An inner surface of the coupling tube 113 is coupled to an outer surface of a lower portion of a bearing housing 120 having a cylindrical shape with an opened top surface.

A bearing 130 is fixed to an inner surface of the bearing housing 120, and a rotation shaft 140 is rotatably supported by the bearing 130. A stator 150 is fixed to the outer surface of the bearing housing 120. A rotor 160 integrally rotating with the rotation shaft 120 is fixed to the outer surface of an upper portion of the bearing housing 120.

The stator 150 includes a core 151 coupled to the outer surface of the bearing housing 120 and a coil 155 wound around the core 151. The rotor 160 includes a rotor yoke 161 and a magnet 165. The rotor yoke 161 has a cylindrical shape having an opened bottom surface. A central portion of a top surface of the rotor yoke 161 is fixed to the rotation shaft 140. The magnet 165 is coupled to an inner surface of the rotor yoke 161 to face the stator 150.

When a current is applied to the coil 155, the rotor 160 rotates due to an electromagnetic force generated between the coil 155 and the magnet 165, and thus, the rotation shaft 140 rotates.

A turntable 170 on which a disk 50 is loaded and supported is fixed to an outer surface of the rotation shaft 140 of an upper side of the rotor yoke 161 to integrally rotate with the rotation shaft 140.

Alternatively, the turntable 170 may be not provided according to a configuration of the rotor yoke 161. For example, the disk 50 may be loaded on the rotor yoke 161.

An attraction magnet 180 is disposed on a surface of the rotor yoke 161 facing the opened top surface of the bearing housing 120 to inhibit the rotor 160 and the rotation shaft 140 from being lifted toward the top surface of the bearing housing 120 when the rotor 160 and the rotation shaft 140 rotate.

In order to generate a uniform electromagnetic field between the stator 150 and the rotor 160, the core 151 is coupled to a desired position of the bearing housing 120.

The spindle motor according to an embodiment includes a guide 122 on the outer surface of the top surface of the bearing housing 120 such that the core 151 is coupled to the desired position of the bearing housing 120. The guide 122 and the bearing housing 120 may be integrated in one body.

The guide 122 is in contact with a top surface of the core 151 to guide a position of the core 151.

The core 151 is coupled to the outer surface of the bearing housing 120 while the core 151 is inserted from a lower side toward an upper side of the bearing housing 120. Here, when the core 151 is inserted toward the upper side of the bearing housing 120 until a top surface of the core 151 is in contact with the guide 122, the core 151 is coupled to the desired position of the bearing housing 120.

The core 151 may be attachably fixed to the bearing housing 120 using an adhesive. At this time, when the adhesive leaks to the outside, peripheral components may be damaged.

In order to inhibit the peripheral components from being damaged, the spindle motor according to an embodiment has a space 123 for storing the adhesive such that the adhesive does not leak to the outside.

In detail, the guide 122 includes a first guide 122a and a second guide 122b. The first guide 122a extends outwardly in a radius direction from the outer surface of the bearing housing 120. The second guide 122b extends in an axis direction from an outer surface of the first guide 122a toward the lower side of the bearing housing 120 to contact with the top surface of the core 151.

Since the second guide 122b is spaced from the outer surface of the bearing housing 120, the adhesive leaking between the bearing housing 120 and the core 151 is stored in the space 123, and thus, the adhesive does not leak to the outside when the core 151 is in contact with the second guide 122b.

That is, when the adhesive is coated on an inner surface of the core 151 or the outer surface of the bearing housing 120, and then, the core 151 is inserted toward the outer surface of the bearing housing 120 in a state where the bearing housing 120 turns upside down, the adhesive leaking toward the guide 122 is stored in the space 123 defined between the bearing housing 120 and the first and second guides 122a and 122b.

As described above, in the spindle motor according to an embodiment, when the core 151 is inserted toward the outer surface of the bearing housing 120 to contact with the guide 122 disposed on the outer surface of the bearing housing 120, the core 151 is coupled to the desired position of the bearing housing 120. Therefore, reliability of the spindle motor is improved.

Any reference in this specification to “one embodiment,” “an embodiment,” “exemplary embodiment,” etc., means that a particular feature, structure, or characteristic described in connection with the embodiment is included in at least one embodiment of the disclosure. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with others of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A spindle motor comprising:
a bearing housing on which a guide is disposed on an outer surface thereof;
a bearing fixed in the bearing housing;
a rotation shaft rotatably supported by the bearing;
a stator fixed to the bearing housing, the stator comprising a core in contact with the guide and a coil wound around the core; and
a rotor fixed to the rotation shaft to rotate by interacting with the stator.

2. The spindle motor according to claim 1, wherein the guide comprises a first guide extending outwardly in a radius direction from an outer surface of the bearing housing and second guide extending downwardly from the first guide.

3. The spindle motor according to claim 2, wherein the second guide is spaced from the outer surface of the bearing housing.

4. The spindle motor according to claim 1, further comprising a base supporting the bearing housing,
wherein the base comprises a coupling tube protruding upwardly and coupled to an outer surface of the bearing housing.

5. The spindle motor according to claim 1, wherein the guide extends from an upper end of the bearing housing.

6. The spindle motor according to claim 1, wherein the guide is integrated with the bearing housing.

7. The spindle motor according to claim 1, further comprising a turntable on which a disk is mounted, the turntable being coupled to the rotation shaft.

8. The spindle motor according to claim 1, wherein the rotor comprises a rotor yoke fixed to the rotation shaft and a magnet coupled to the rotor yoke to face the stator.
